(19) United States
(12) Patent Application Publication
(10) Pub. No.: US 2020/0143303 A1
(43) Pub. Date: May 7, 2020

(54) SYSTEM AND METHOD FOR STRUCTURING DATA FOR ANALYSIS

(71) Applicant: Uniphore Software Systems Private Limited, Taramani (IN)

(72) Inventors: Parameswaran E K, Nanganallur (IN); Umesh Sachdev, Fremont, CA (US)

(21) Appl. No.: 16/273,275

(22) Filed: Feb. 12, 2019

(30) Foreign Application Priority Data
Nov. 5, 2018 (IN) 201841041892

(51) Int. Cl. G06Q 10/06; G10L 15/26; G06F 16/383

(52) U.S. Cl. CPC G06Q 10/0637; G06F 16/383; G10L 15/265; G06Q 10/0639

(57) ABSTRACT

An analysis system for increasing an efficiency of analysis of customer inputs, is provided. The system includes a structuring module configured to structure a business objective. The system further includes an object of analysis (OA) module configured to enable one or more users to articulate a set of business objectives. The set of business objectives are defined to address a reason for performing the analysis. The system further includes a subject of analysis (SA) module configured to frame a plurality of subjects for each business objective. The plurality of subjects is framed to define each business objective. In addition, the system includes a predicate of analysis (PA) module configured to define a plurality of predicates used to measure each subject. The plurality of predicates employs one or more evaluation modules to measure each subject. Furthermore, the system includes an analysis unit module configured to generate a plurality of analysis units. Each analysis unit comprises a representation of a combination of the objectives, and its corresponding subjects and predicates.

### PRIORITY STATEMENT

The present application claims priority under 35 U.S.C. § 119 to Indian patent application number 201841041892 filed 5 Nov. 2018, the entire contents of which are hereby incorporated herein by reference.

### FIELD

The present invention in general relates to data analysis systems and more particularly to a system and method for structuring data for effective analysis.

### BACKGROUND

Various business organizations require data analysis of large and complex datasets, involving a large number of measured variables. Data analysis provides various insights for a business organization which can be used to improve organization goals, measure efficiency, measure performance of employees etc. Specifically, such analysis of various datasets assists an organization to identify structures or relationships between the operating data which in turn helps in managing business information, operations and predictive planning. However, due to extremely large datasets, it is often difficult and tedious process to evaluate hidden structures and/or relationships for managing business data.

One example of such a business organization is a customer contact center which typically deals with large amounts of recorded speech data. Speech processing systems are usually employed for processing the customer-agent conversation. Insights are extracted from the processed data and then used to improves several organizational goals such as delivering superior customer experience, reducing turn-around time, etc. More particularly, speech analysis helps in identifying critical business metrics like professional performance score, customer satisfaction (CSAT) score, net promoter score, etc.

Conventional methods for speech processing include recording the conversations, converting speech data into corresponding text data and manually analyzing the recorded content. The text data is then further analyzed using various text analysis methods which typically focuses on keywords or phrases. However, most data analysis systems capture transactional speech data which typically includes a tremendous amount of unstructured data for analysis.

Analyzing large amounts of unstructured data requires labor intensive tasks and may be susceptible to human error. Thus, the process becomes complex and time consuming. In addition, for existing analysis systems to perform optimally, it is often required for an analyst to manually provide an effective structure for the unstructured data. This additional formatting of unstructured data lead to longer transcription times and reduced productivity.

Moreover, the scenarios at business organization are dynamic and the conventional methods do not have the capability to automatically create and deploy new analytical models to cater to dynamic business goals. Large amounts of unstructured data will hamper the effectiveness of the data analysis models.

Therefore, there is a need for an automated and computationally efficient system for structuring data which leads to effective data analysis.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide a system and method for structuring data for analysis.

Briefly, according to an example embodiment, a structured analysis system for increasing an efficiency of analysis of customer inputs is provided. The system includes an object of analysis (OA) module configured to enable one or more users to articulate a set of business objectives. The set of business objectives are defined to address a reason for performing the analysis. The system further includes a subject of analysis (SA) module configured to frame a plurality of subjects for each business objective. The plurality of subjects is framed to define each business objective. The system includes a predicate of analysis (PA) module configured to define a plurality of predicates used to measure each subject. The plurality of predicates employs one or more evaluation modules to measure each subject. In addition, the system further includes an analysis unit module configured to generate a plurality of analysis units. Each analysis unit comprises a representation of a combination of the objectives, and its corresponding subjects and predicates

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an example embodiment of an analysis system adapted for structuring data, implemented according to aspects of the present technique;

FIG. 2 illustrates is an example business objective defined by a business analyst, implemented in accordance with an exemplary embodiment of the present technique;

FIG. 3 is a block diagram of an embodiment of a computing device in which the modules of the analysis system adapted for structuring data, described herein, are implemented.

### DETAILED DESCRIPTION OF EXAMPLE EMBODIMENTS

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The analysis system described below enables structuring of data in analytics solutions, which often assists organizations, such as contact centers, business process outsourcing centers and the like. For the purpose of this description, the following embodiments are described with respect to contact centers and/or business process outsourcing centers. The different aspects of the present technique are described in further detail below.

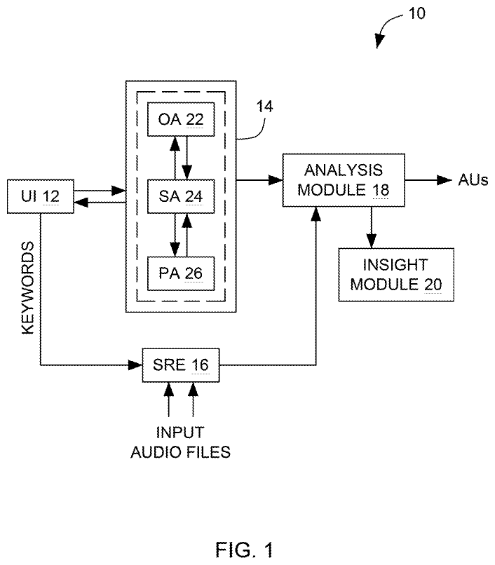

FIG. 1 is a block diagram of one embodiment of an analysis system implemented according to aspects of the present technique. Analysis system 10 is configured to enable an analyst to articulate business objectives for effective data analysis. Analysis system 10 includes user interface 12, structuring module 14, speech recognition engine 16, analysis module 18 and insight module 20. The manner in which the analysis system 10 operates is described in further detail below.

User interface (UI) 12 is configured to enable one or more users to provide a set of business objectives. As used herein, the one or more users include data analysts or customer service professionals. UI 12 enables the user to define many aspects of the business objective that is relevant for the required data analysis.

Structuring module 14 is configured to structure the business objective into further levels. Structuring module 14 includes an object of analysis (OA) module 22, a subject of analysis (SA) module 24 and a predicate of analysis (PA) module 26. Each modules is described in further detail below.

Object of Analysis (OA) module 22 is configured to define a set of business objectives. The set of business objectives are defined to address a business objective for which data analysis is performed. Examples of business objectives may include reducing calls, increase profit margin, increase efficiency, improve employee training and the like.

Subject of Analysis (SA) module 24 is configured to one or more subjects for each business objective defined above. In one embodiment, each object includes at least one subject. In one embodiment, the user interface 12 is configured to provide a set of subjects associated to the set of business objective. In a further embodiment, the subjects for each object are automatically prompted to the user.

Predicate of Analysis (PA) module 26 is configured to define one or more predicates used to measure each subject. In one embodiment, the user interface 12 is configured to provide predicates associated to each subject. In one embodiment, the PA module employs one or more evaluation modules to measure each subject. The user interface 12 is further configured to enable the user to select one or more evaluation modules associated for a selected predicate. In one embodiment, the evaluation modules include descriptor model, system model, drill down model and cross reference model.

Speech recognition engine (SRE) 16 is configured to receive raw data and to generate input data for further analysis. In one embodiment, the input data files comprise audio files. The speech recognition engine 16 is configured to identify relevant data from the raw data files. The relevant data files may be identified using a set of keywords defined by the user.

Analysis module 18 configured to generate one or more analysis units based on the defined object and the input data files. In one embodiment, each analysis unit is a representation of a combination of the objectives and its corresponding subjects and predicates. In one embodiment, the analysis module is configured to receive metadata related to the audio calls and/or the business organization. Here, metadata comprises information regarding various attributes of the audio file such as call duration, speech overlap, key word counts, instances, silence, talkover, etc.

In this example, the analysis module 18 measures the breadth and width of haystack of the data, further quantified in analysis units in accordance with the following relationship:

AU=OA*{SA1 . . . SAn}*{PA1 . . . PAn}

where SA is the subject of analysis;

OA is the object of analysis;

PA is the predicate of analysis; and

AU is analysis unit.

Insight module 20 is configured to extract a plurality of insights from the plurality of analysis units. In one embodiment, an efficiency of the analysis system is measured by a ratio between the insights computed versus the total number of analysis units generated by analysis module 18. The manner in which the analysis system operates is described below with an example.

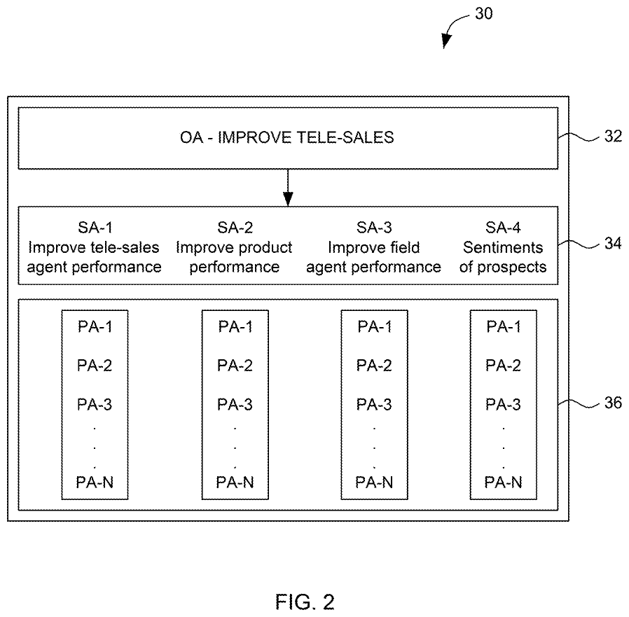

FIG. 2 illustrates is an example business objective defined by a business analyst, implemented in accordance with an exemplary embodiment of the present technique. For exemplary purposes only, the business objective is defined with reference to a customer-agent interaction that occurs typically in a contact center of a medical insurance company. Each step is described in further details below.

At step 32, an exemplary business objective is defined. In one example business objectives may include general statements of desired business outcomes, the specific steps or actions required to reach business goals. For example, an objective from a business analyst is “improve tele sales” occurring in a contact center at any time.

At step 34, the subjects related to the business objective defined in step 32, are defined. The subjects are represented by reference numerals SA1, SA2, SA3, SA4. For example, for the object “improve tele sales”, the related subjects may include “improve tele sales agent performance”, “improve product performance” and “improve field agent performance”, further “sentiments of prospects”. In one embodiment, the business analyst may require holding discussions with the customers, for creating a list of potential subjects of analysis. In this example the list may be created by examining the object of analysis and/or based on common knowledge or by way specific external research on the object of analysis.

In a further embodiment, several drivers may employ to enumerate the root causes for each subject. In one example, for subject “improve tele sales agent performance”, drivers may include compliance to script, sales pitching, objection handling etc. Further, subject such as “sentiments of prospects”, may be driven with positive sentiments, negative sentiments and the like. Further, subjects can be drilled down into their underlying causation, to model the outcome of the subject as a causation of multiple driver chains underneath it. In this example cause & effect phenomenon technique may be used for modelling the subjects such as Fish bone diagram or Ishikawa diagram. However, a variety of other modelling techniques may be envisaged.

At step 36, the predicates for measuring each subject are defined. In this embodiment, the predicates of analysis are represented by reference numerals PA1, PA2, PA3 through PAn. These predicates can be accurately defined with the help of the evaluation modules, to measure each subject. In one embodiment, the evaluation modules, automatically sets in to collect, categorize, correlate and cross-reference across the entire data set (without limiting to a specific data set) that will provide the root causes that recommends further actions, which in turns leads to the desired business objective which is “improve tele sales”.

In a further embodiment, the predicate of analysis is essentially a meta structure that uses certain constructs which will help in discovering and computing analysis units from the subject of analysis. These constructs for predicate of analysis may include evaluation models such as descriptor model, system model, drill down model and cross reference model.

By defining the object, subject and predicate in this way, efficiency of analysis can be improved. By defining and breaking down ambiguous and unstructured data in a hierarchical fashion and structuring them in meaningful tree network that can be subjected to logical selection. Furthermore, the predefined values of Object-Subject-Predicate help the user to choose more relevant combination. As a management tool to ease management of analysis.

The analysis units (AU) are generated based on the object, subjects and the predicates along with the input data files. AU based tracking creates better traceability and provides both back ward traceability to objects/subjects and forward traceability to insights.

In addition, the “Subject of Analysis” is the combined effect of potential causes which creates an “effect” and impact on the “Subject of Analysis” modelled. However, to determine the absolute and differential impact of each of the causes it is required to study the relation of every cause on the effect individually and collectively. Typically, the impact of the causes on the subject will need to be drilled down further by certain filters to study it more closely. In one example, such filters may be implemented based on certain factors such as driver hierachy, time hierarchy, profile hierarchy, frequency of an outcome and the like. Analysis Unit is the label given to these filtered units and defining each such report uniquely and also provides the needed insights to the specific instance of “subject-object-predicates” combination. In one example, the analysis unit works as junction box for connecting the planning and configuration aspect of analysis and insight discovery to provide change in management portion of analytics implementation.

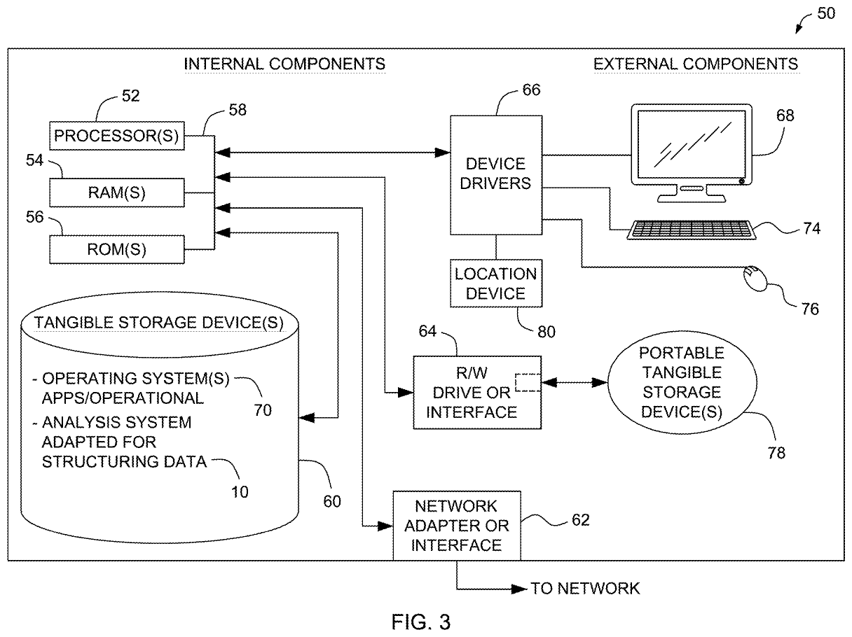

The modules of analysis system 10 for structuring data described herein are implemented in computing devices. One example of a computing device 50 is described below in FIG. 3. The computing device includes one or more processor 52, one or more computer-readable RAMs 54 and one or more computer-readable ROMs 56 on one or more buses 58. Further, computing device 50 includes a tangible storage device 60 that may be used to execute operating systems 70 and the analysis system 10. The various modules of the analysis system 10 include user interface 12, structuring module 14, speech recognition engine 16, analysis module 18 and insight module 20. Both, the operating system 70 and the analysis system 10 are executed by processor 52 via one or more respective RAMs 54 (which typically include cache memory). The execution of the operating system 70 and/or the system 10 by the processor 52, configures the processor 52 as a special purpose processor configured to carry out the functionalities of the operation system 70 and/or the analysis system 10, as described above.

Examples of storage devices 60 include semiconductor storage devices such as ROM 56, EPROM, flash memory or any other computer-readable tangible storage device that may store a computer program and digital information.

Computing device also includes a R/W drive or interface 64 to read from and write to one or more portable computer-readable tangible storage devices 78 such as a CD-ROM, DVD, memory stick or semiconductor storage device. Further, network adapters or interfaces 62 such as a TCP/IP adapter cards, wireless Wi-Fi interface cards, or 3G or 4G wireless interface cards or other wired or wireless communication links are also included in computing device.

In one example embodiment, the analysis system 10 which includes the user interface 12, structuring module 14, speech recognition engine 16, analysis module 18 and insight module 20, may be stored in tangible storage device 60 and may be downloaded from an external computer via a network (for example, the Internet, a local area network or other, wide area network) and network adapter or interface 62.

Computing device further includes device drivers 66 to interface with input and output devices. The input and output devices may include a computer display monitor 68, a keyboard 74, a keypad, a touch screen, a computer mouse 76, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other exemplary features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTMLS, Ada, ASP (active server pages), PHP, Scala, Eiffel, Smalltalk, Erlang, Ruby, Flash®, Visual Basic®, Lua, and Python®.

1. An analysis system for increasing an efficiency of analysis of customer inputs, the analysis system comprising:
a structuring module configured to structure a business objective, the structuring module comprising;
an object of analysis (OA) module configured to enable one or more users to articulate a set of business objectives; wherein the set of business objectives are defined to address a reason for performing the analysis;
a subject of analysis (SA) module configured to frame a plurality of subjects for each business objective; wherein the plurality of subjects is framed to define each business objective; and
a predicate of analysis (PA) module configured to define a plurality of predicates used to measure each subject; wherein the plurality of predicates employs one or more evaluation modules to measure each subject; and
an analysis unit module configured to generate a plurality of analysis units; wherein each analysis unit comprises a representation of a combination of the objectives, and its corresponding subjects and predicates.

2. The analysis system of claim 1, further comprising a user interface configured to enable the one or more users to provide a set of business objectives to the OA module.

3. The analysis system of claim 2, wherein the user interface is configured to provide a set of pre-defined subjects associated to the set of business objective provided by the user.

4. The analysis system of claim 3, wherein the user interface is configured to provide a set of pre-defined predicates associated to each subject provided by the user.

5. The analysis system of claim 4, wherein the user interface is configured to enable the user to select one or more evaluation modules associated with each predicate.

6. The analysis system of claim 1, further comprising a speech recognition engine (SRE) configured to receive raw data and to generate input data for analysis.

7. The analysis system of claim 1, further comprising an insight module configured to extract a plurality of insights from the plurality of units.

8. An analysis method for increasing an efficiency of analysis, the analysis method comprising:
structuring a business objective by;
articulating a set of business objectives; wherein the set of business objectives are defined to address a reason for performing the analysis;
framing a plurality of subjects for each business objective; wherein the plurality of subjects is framed to define each business objective; and
defining a plurality of predicates used to measure each subject; wherein the plurality of predicates employs one or more evaluation modules to measure each subject; and
representing a combination of the objectives, and its corresponding subjects and predicates in a structured manner.

9. The analysis method of claim 8, enabling the one or more users to provide a set of business objectives to the OA module; wherein a set of pre-defined subjects associated to the set of business objective is also provided to the user; and wherein a set of pre-defined predicates associated to each subject is also provided to the user.

10. The analysis method of claim 9, further comprising enabling the user to select one or more evaluation modules associated with each predicate.
